(19) United States
(12) Patent Application Publication
(10) Pub. No.: US 2011/0027755 A1
(43) Pub. Date: Feb. 3, 2011

(54) DENTAL IMPLANT FOR LATERAL INSERTION

(76) Inventor: Gerard Scortecci, Nice (FR)

Correspondence Address: YOUNG & THOMPSON, 209 Madison Street, Suite 500, Alexandria, VA, 22314, US

(21) Appl. No.: 12/528,390

(22) PCT Filed: Feb. 27, 2008
(86) PCT No.: PCT/EP08/52394

§ 371 Date: Oct. 22, 2010

(30) Foreign Application Priority Data
Mar. 2, 2007 (FR) 0753623

(51) Int. Cl. A61C 8/00

(52) U.S. Cl. 433/174

(57) ABSTRACT

A dental implant for lateral insertion includes a longitudinal shaft (1) and at least one lateral portion (2) oriented in a plane inclined relative to the longitudinal shaft (1) at least one zone having a relief bearing on the bone, inclined relative to longitudinal shaft (1) and configured to create a displacement of the entire implant with an axial component during implant insertion. The implant ensures a better hold in the receiving site and an easy insertion. The implant is useful in the field of dental surgery, especially the insertion, of dental prosthesis in edentulous patients.

This invention concerns a dental implant for lateral insertion used to install a prosthetic assembly.

The invention's application is to be found in dental surgery, in particular for implantation of dental prosthesis in edentulous patients.

Laterally inserted implantable devices implanted after a lateral osteotomy comprising a base portion oriented appreciably perpendicular to a stem portion, of the type described in the applicant's documents FR-A-2596273 and FR-A-2863477 are already known in this field. These implantable devices are inserted with a pure translation movement using a mallet and a punch, the impacts of which are unpleasant for the patient and can generate micro-cracks in the jawbones.

However, the applicant has noted that the characteristics of these implants can be further improved, in particular for better anchoring.

One of the advantages of the implant proposed is that its surface comprises a relief configured to create a movement with an axial component during lateral insertion of the implant.

The combination of a lateral and axial displacement during insertion of a laterally inserted dental implant improves the primary retention of the implant by creating compression that favors implant blocking.

According to one of the preferred embodiments, the implant has a rotational symmetry and the relief is formed by a thread. The thread helps to retain the implant by increasing the area of contact between the bone and the implant. The thread also acts as a screw tap that adjusts the receiving bed to the exact shape of the implant and thus maintains the implant blocked in the bone.

According to this embodiment, the implant rotates and translates during insertion; installation then becoming less stressful and damaging.

The invention allows the use of CAD/CAM, Computer Aided Design/Computer Aided Manufacturing, to fabricate the immediate prosthetic device and surgical guides prior to installing the implants so that they can be installed precisely and according to a schedule in accordance with the invention.

Other goals and advantages will arise in the following description of a preferred embodiment.

First of all, it has to be remembered that the present invention concerns a dental implant for lateral insertion comprising a longitudinal axis and at least one lateral portion oriented in a plane inclined relative to the longitudinal axis, characterized in that it comprises a zone comprising a relief bearing on the bone, inclined relative to the longitudinal axis and configured to create a displacement of the entire implant with an axial component upon insertion of the implant.

According to preferred embodiments, this implant is such that:
it has a rotational symmetry
the relief is formed by a thread
the displacement of all the implant is helicoidal
the angle formed by the flanks of the thread is approximately equal to 60°
the thread is self-tapping
the longitudinal axis comprises a head and a trunk of different diameters.
the head has a diameter greater than the trunk
the surface between the head and the trunk is beveled
the beveled surface forms an angle of less than 45° relative to perpendicular direction of the trunk
the zone with the relief covers all or part of the head, the trunk or the lateral portion
the zone with the relief includes the head, the trunk and the lateral portion.
the lateral portion comprises sharpened teeth at its periphery
   Another object of this invention concerns a dental implantology device comprising a dental implant for lateral insertion, as described previously, and displacement means of the implant configured to impart to the implant a lateral translation coupled with rotation.

The drawings attached are given as examples and are not restrictive. They show only one embodiment of the invention and enable it to be understood easily.

FIG. 1: Side view of the implant according to a preferred embodiment.

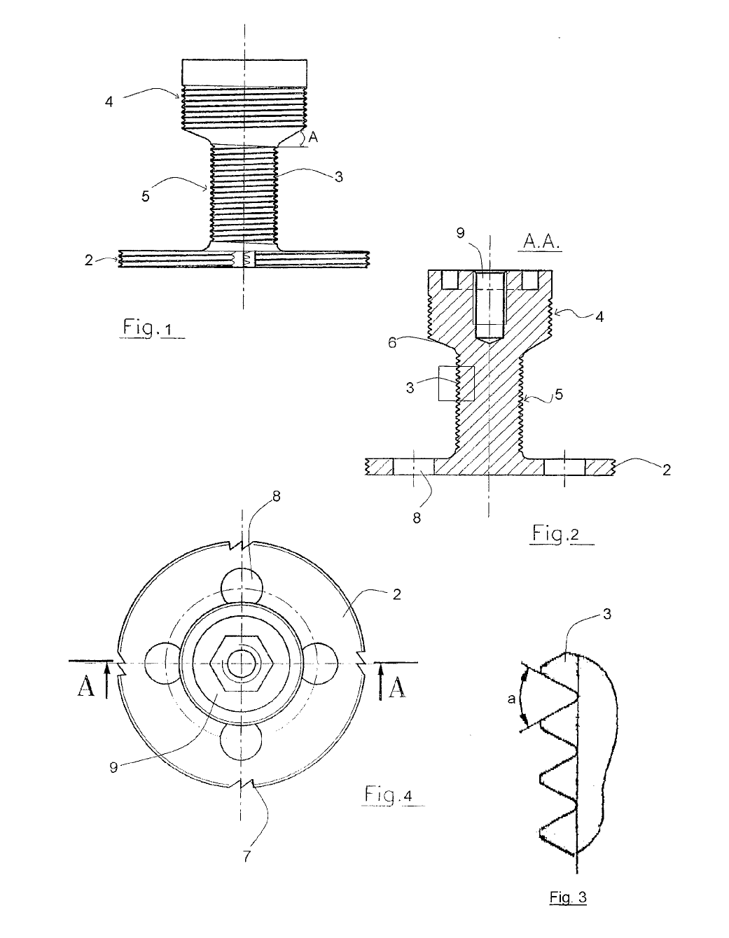

FIG. 2: Sectional view of the implant according to FIG. 1

FIG. 3: Enlargement of the flank of the implant thread.

FIG. 4: View of the top of the implant.

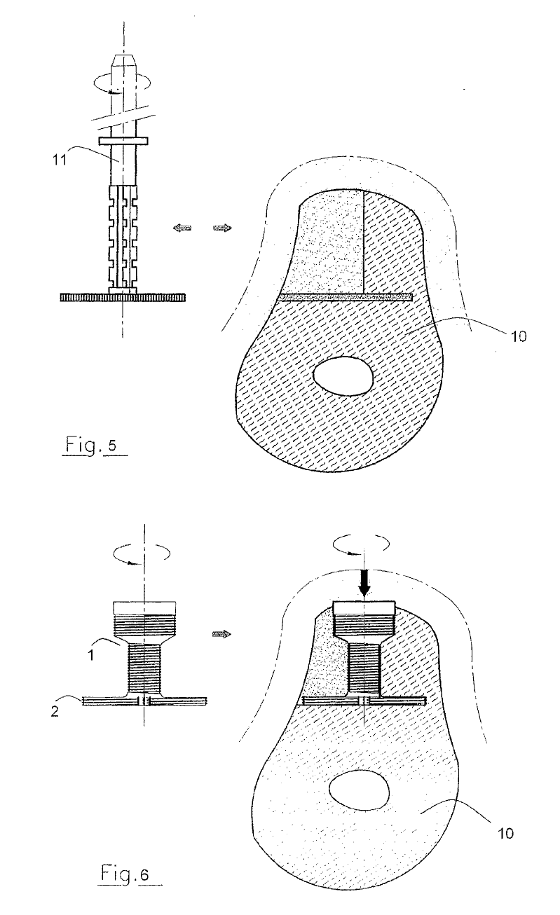

FIG. 5: Side view of a cutter and a jaw bone.

FIG. 6: Side view of implant insertion in the jaw bone.

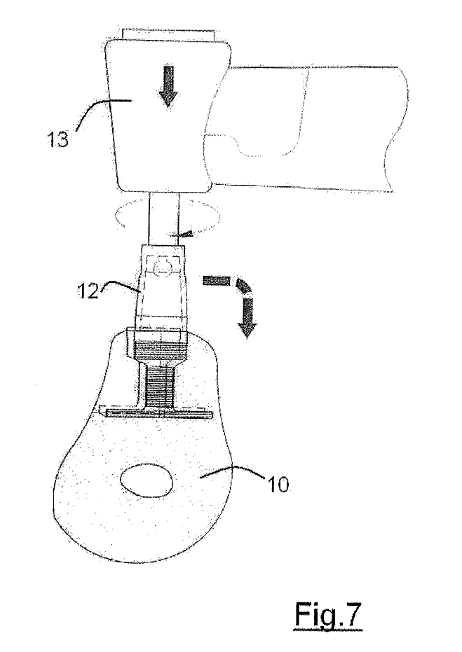

FIG. 7: Side view of implant insertion in the jaw bone using a contra-angle handpiece.

The dental implant according to the invention generally has a longitudinal axis (1) and a lateral portion (2) and characteristically at least one zone configured with a relief inclined relative to longitudinal axis (1) configured to create a displacement with an axial component during implant insertion.

The lateral portion (2) is oriented in a plane inclined relative to the longitudinal axis (1), preferably perpendicular to it, as in the case shown.

The assembly thus formed can be buried in jaw bone (10) by lateral insertion after a lateral osteotomy with abundant irrigation using a disc or an oscillating saw in order to prepare the endo-bone bed of the implant.

Moreover, the implant according to the invention has a rotational symmetry.

Thus, longitudinal axis (1) is cylindrical as lateral portion (2) which has a wheel shape.

Thus, the relief consists of a thread (3).

According to the embodiment shown in the figures, longitudinal axis (1) includes a head (4) and a trunk (5) of different diameters.

Advantageously, head (4) has a diameter greater than trunk (5).

The difference in size between trunk (5) and head (4) forms a beveled surface (6). This beveled surface (6) creates an additional bearing surface for the implant on the bone of the receiving bed.

Advantageously, this beveled surface (6) forms an angle (A) of less than or equal to 45° relative to the direction perpendicular to trunk (5).

This maximum angle is advantageously selected to create the largest possible axial support. However, this angle (A) may have other values for other uses.

The difference in diameter between trunk (5) and head (4) helps to maintain the implant by limiting its axial displacement. The diameter of trunk (5) is advantageously less than that of head (4) but also that of lateral portion (2). Once the implant installed, the bearing surfaces created between head (4) and trunk (5) and between lateral portion (2) and trunk (5) restrict unwanted axial movement of the implant, thereby avoiding it sinking or exiting from jaw bone (10).

Thread (3) can be placed on all or part of head (4), trunk (5) or lateral portion (2). Advantageously, head (4), trunk (5) and lateral portion (2) are threaded (3).

Thread (3) is undercut to create an intra-bone micro-thread corresponding very precisely to the bed receiving the implant.

Angle (α) formed by the flanks of thread (3) is advantageously approximately 60° to encourage anchoring of the implant in bone (10). However, this angle (α) can have other values for other uses compatible with compression screwing.

Thread (5) increases the bearing surface of the implant on the jaw bone and contributes to limiting the uncontrolled axial displacements of the implant.

In the case shown, lateral portion (2) comprises sharpened teeth (7) designed to adapt exactly the receiving bed to the implant during its insertion.

Conventionally, implant's head (4) comprises connection means (9) ready to co-act with a mandrel and/or co-act with a prosthetic device.

Thus, connection means (9) can be internally or externally polygonal, internally or externally threaded or with any other form that will retain the prosthetic device.

Advantageously, a T osteotomy is performed conventionally using an approved cutter for the implant according to the invention (not shown) or several cutters can be used successively to obtain a T osteotomy corresponding exactly is to the implant according to the invention. For example, a first cutter (11) shown on FIG. 5, consisting of a single longitudinal axis and a lateral portion, can be used, followed by the use of a cutter corresponding to head (4) of the implant.

Preferably, the receiving bed is slightly smaller than the implant itself. Thus, the implant according to the invention is inserted in the receiving bed of the jaw bone using displacement means that co-act with connection means (9).

The displacement means are advantageously configured to apply on the implant a lateral translatory movement coupled with rotation.

The presence of thread (3) on the implant generates a helicoidal movement to all the implant. The helicoidal movement allows the implant to be locked in position by creating compression on the jaw bone.

In this way, the implant is no longer impacted by a mallet, thereby reducing the risks of microcracks and intraosseous apoptosis.

Advantageously, the displacement means consist of a mandrel (12) connected to a geared contra-angle (13) of a micro motor allowing mild and atraumatic installation of the implant. It is preferable to use a contra-angle geared device to generate torque of at least 20 Ncm (Newton centimeter).

FIG. 7 shows the insertion of the implant according to the invention using a mandrel (12) and a contra-angle geared device (13) connected to a micro-motor.

FIG. 7 shows the displacement of the implant according to a translation and axial movement. These two positions of the implant are shown, one by dotted lines and the other by full lines. The position shown by the dotted lines precedes in time the one shown by full lines when inserting the implant.

It has to be noted that if the implant has to be withdrawn, this is carried out using the same displacement means as during insertion. However, the to contra-angle geared device is in reversed mode. Thus, the implant undergoes rotation and translation in the opposite direction to the one applied during insertion.

Guidance means can be used to proceed to the osteotomy and then to make the insertion of the implant in the receiving bed easier.

The guidance means allow the cutter and/or the implant to slide laterally and can be equipped with an integrated depth indicator.

The guidance means may, for instance, consist of a surgical guide of the type placed astride the gingiva alveolar ridge with drill bushes.

The trajectory of the surgical guide can be generated mechanically or by computer means, in particular by a numerically controlled machine.

The thread (3) allows the tapping of the receiving bed at the last minute during the insertion of the implant. This encourages its retention in place.

According to one possibility, the implant is first inserted laterally then, when most of the surface of the implant comes into contact with the receiving bed, thread (3) creates rotational movement of the implant which helps to create axial displacement of the implant, thus leading to final blocking with a light prestressing to encourage its correct retention in position, good osteo-integration and osteogenesis.

According to a variant, the implant undergoes translatory movement coupled with rotation at the start of insertion, the implant thereby translating laterally at the same time as it rotates.

The thread (3) also has the advantage of considerably increasing the osteo integration and osteogenesis.

According to different embodiments, the implant may show an extension of its longitudinal axis (1) beyond lateral portion (2).

Similarly, the implant may have multiple lateral portions (2).

Advantageously, the entire dental implant consists of a single part in titanium or titanium alloy through-machined without addition of any filler product.

In another version, the implant can also be manufactured as a single part in zirconium ceramic or with zirconium body on which is fitted a titanium emergence in order to help screwing of the prosthetic device and serve as the damper to absorb the extreme hardness of the zirconium.

Conventionally, lateral portion (2) can be equipped with holes (8) encouraging the bone to regrow and thus to retain implant (1) in position in the jaw bone.

According to other possibilities not shown, the relief on the implant consists of inclined projections.

According to this embodiment, the implant does not have a rotational symmetry.

The inclination of the projections can be identical to the inclination of the lateral portion (2).

According to this embodiment, the implant is inserted in the jaw bone receiving bed using a mallet with the result that the implant will undergo a lateral translation with an axial component.

Generally the implant is inserted in the jaw bone so as to allow the upper part of the implant for installing the prosthetic device to appear on the surface of the gingiva.

According to another embodiment, the implant can be completely hidden in the bone or the gingiva.

### REFERENCES

1. Longitudinal axis
2. Lateral portion
3. Thread
4. Head
5. Trunk
6. Beveled surface
7. Teeth
8. Holes
9. Connection means
10. Gingiva bone
11. Cutter
12. Mandrel
13. Contra-angle gearing
A. Angle
a. Thread flank angle

1. A dental implant for lateral insertion comprising a longitudinal shaft (1) and at least one lateral portion (2) oriented in a plane inclined relative to the longitudinal shaft (1) characterized in that it comprises at least one zone having a relief bearing on the bone, inclined relative to the longitudinal shaft (1) and configured to create a displacement of the entire implant with an axial component during implant insertion.

2. Dental implant according to the claim 1 in which the implant has a rotational symmetry.

3. Dental implant according to claim 1 in which the displacement of all the implant is helicoidal.

4. Dental implant according to claim 1 in which the relief is formed by a thread (3).

5. Dental implant according to claim 4 in which angle (A) formed by the flanks of the thread (3) is approximately 60°.

6. Dental implant according to claim 4 in which the thread (3) is self-tapping.

7. Dental implant according to claim 1 in which the longitudinal shaft (1) comprises a head (4) and a trunk (5) of different diameters.

8. Dental implant according to claim 7 in which the head (4) has a diameter greater than the trunk (5).

9. Dental implant according to claim 7 comprising a beveled surface (6) between the head (4) and the trunk (5).

10. Dental implant according to claim 9 in which the beveled surface (6) forms an angle (A) which is less than 45° relative to the direction perpendicular to the trunk (5).

11. Dental implant according to claim 7 in which the surface bearing the relief consists of all or part of the head (4), the trunk (5) or the lateral portion (2).

12. Dental implant according to claim 7 in which the surface bearing the relief includes the head (4), the trunk (5) and the lateral portion (2).

13. Dental implant according to claim 1 in which the lateral portion (2) has sharpened teeth (7) on its periphery.

14. Dental implantology device comprising a dental implant for lateral insertion characterized in that it comprises an implant according to claim 1 and implant displacement means configured to impart to the implant a lateral displacement coupled with rotation.
